(19) United States
(12) Patent Application Publication
(10) Pub. No.: US 2011/0083361 A1
(43) Pub. Date: Apr. 14, 2011

(54) PROCESSING PAINT OVERSPRAY FROM AN EMULSION CHEMISTRY TO PRODUCE ALTERNATIVE RECYCLE PRODUCTS

(75) Inventors: Paul Sikora, Troy, MI (US); Christopher Hubb, Belleville, MI (US); Joe McCarty, Clarkston, MI (US)

(73) Assignee: Abednego Enviornmental Services, LLC, Northville, MI (US)

(21) Appl. No.: 12/904,256

(22) Filed: Oct. 14, 2010

Related U.S. Application Data
(60) Provisional application No. 61/251,368, filed on Oct. 14, 2009.

(51) Int. Cl. C08J 11/04; C10L 5/00; B01D 11/04

(52) U.S. Cl. 44/607; 521/40; 422/256

(57) ABSTRACT

A method for processing paint overspray from an emulsion chemistry process which includes collecting the paint overspray in an aqueous medium, subjecting the paint overspray to a chemical treatment to form an aqueous suspension or emulsion of paint overspray solids having a first solids content and processing the aqueous suspension or emulsion of paint overspray solids to form: i) a light phase that has a second solids content that is lower than the first solids content; and ii) a heavy phase that has a third solids content that is higher than the first solids content. The light phase is recycled back into the process together with dispersion chemistry contained therein and the heavy phase can be used as a coating composition or as a combustible fuel or fuel additive.

### RELATED APPLICATION

The present application is based upon U.S. Provisional Patent Application Ser. No. 61/251,368, filed Oct. 14, 2009, to which priority is claimed under 35 U.S.C. §120 an of which the entire disclose is hereby incorporated by reference.

### TECHNICAL FIELD

The present invention relates generally to processing paint overspray from a water wash system. In particular, the present invention is directed to a method of producing a recyclable process stream of a product from paint overspray which method involves chemical processing and separating of water from paint solids. The process produces a concentrated solids phase that can be used as an alternative fuel or recycled as re-usable paint product.

### BACKGROUND ART

Paint overspray poses a serious and expensive waste disposal problem for painting operations in manufacturing plants. When an object such as an automobile assembly or component is painted in a paint spray booth, the excess paint or overspray is typically chemically treated and collected in a water curtain and/or in a water stream underneath floor grating beneath the paint booth. This collected material is known as paint sludge. Disposing of paint overspray waste poses a problem of considerable complexity to paint booth operators. Current disposal technology is based upon incineration, or chemical and/or physical treatment together with solidification for purposes of landfill disposal. However, the disposal of paint overspray in landfills raises environmental concerns due to the fact that paint overspray typically contains numerous hazardous components. Such environmental concerns create the potential for long term liabilities and incur costs for special precautions that are needed to handle such waste materials.

Attempts have been made to create useful byproducts from paint overspray in order to gain or recover some value and lower the overall costs of processing the paint waste. Most of these attempts involved complex, potentially dangerous and problematic processing steps which add to the overall processing costs. Such high costs severely limit commercial interest in processing paint overspray.

Processing of paint overspray is time consuming and costly. Accordingly, there is need for a simple process that effectively collects and uses all of the paint overspray solids generated by paint booth facilities.

Landfill disposal of paint solids is an environmentally undesirable method of disposing of waste paint solids. Accordingly, there is a need for a better alternative method for disposal or recycling of waste paint overspray.

The present invention provides a simple and economic process for collecting, processing and using all of the paint overspray solids generated by paint booth facilities. Moreover, the present invention provides a method of recovering, recycling/reusing paint overspray. Further, the present invention provides a method of producing a combustible fuel product from paint overspray which can be used to supplement fuel supplies used in power and heat generating plants and similar facilities and applications.

### DISCLOSURE OF THE INVENTION

According to various features, characteristics and embodiments of the present invention which will become apparent as the description thereof proceeds, the present invention provides a method of processing paint overspray from an emulsion chemistry process which involves the steps of:

a) obtaining paint overspray from a painting facility;

b) collecting the paint overspray in an aqueous medium;

c) subjecting the paint overspray to a chemical treatment to form an aqueous suspension or emulsion of paint overspray solids having a first solids content; and

d) processing the aqueous suspension or emulsion of paint overspray solids to form: i) a light phase that has a second solids content that is lower than the first solids content; and ii) a heavy phase that has a third solids content that is higher than the first solids content.

The present invention further provides a system for processing paint overspray from an emulsion chemistry process which includes:

at least one spray paint application station;

an aqueous medium for collecting paint overspray from the at least one spray paint application station;

means for adding chemical agents to the collected paint overspray to form an aqueous suspension or emulsion of paint overspray solids having a first solids content; and

a liquid-liquid separator for processing the aqueous suspension or emulsion of paint overspray solids to form: i) a light phase that has a second solids content that is lower than the first solids content; and a heavy phase that has a third solids content that is higher than the first solids content.

### BRIEF DESCRIPTION OF DRAWINGS

The present invention will be described with reference to the attached drawings which are given as non-limiting examples only, in which:

FIG. 1 is a diagram of a method for processing paint overspray according to one embodiment of the present invention.

FIGS. 2a and 2b depict samples of aqueous suspensions or emulsions of paint overspray having different solids percentages that have settled.

FIG. 3 depicts a sample of an aqueous suspension or emulsion of paint overspray that has a solids content of about 50 wt. %.

### BEST MODE FOR CARRYING OUT THE INVENTION

The present invention is directed to a method of producing a recycled process stream or a product from paint overspray which involves chemical processing and separation of water from paint solids to produce process stream or a product that can be used as an alternative fuel or recycled as re-usable paint product. Further the present invention is directed to a method of processing paint overspray to produce a paint polymer that can be recycled and reused

According to the present invention raw (or untreated) paint overspray from a painting operation is processed by collecting the paint overspray particles in a water curtain and/or in a water stream that is provided beneath the floor grating of a paint booth. The collected paint overspray particles are chemically treated using dispersion technology systems/chemicals which cause the paint overspray particles to be emulsified and suspended in the water used to collect/recover the paint overspray particles. The resulting aqueous suspension or emulsion is sent to a sludge pit or holding tank from which a portion of the aqueous suspension or emulsion is recycled in the water curtain and/or the water stream that is provided beneath the floor grating of a paint booth.

In a typical system that collects and recovers paint overspray the solids percent (by weight) in the aqueous suspension or emulsion generally ranges from about 1 to about 25% by weight.

According to the present invention a portion of the aqueous suspension or emulsion is removed from the sludge pit or holding tank and processed into a “light phase” that has a lower solids content than the bulk volume of the aqueous suspension or emulsion that is contained within the sludge pit or holding tank and a “heavy phase” that has a higher solids content than the bulk volume of the aqueous suspension or emulsion that is contained within the sludge pit or holding tank. The “light phase” is returned to the sludge pit or holding tank or to the water curtain and/or water stream provided beneath the floor grating of a paint booth and the “heavy phase” is collected for disposal or further processing as discussed below.

According to one embodiment of the present invention the aqueous suspension or emulsion is removed from the sludge pit or holding tank and processed into a “light phase” and a “heavy phase” (or “dirty phase”) using a liquid to liquid separation unit. During the course of the present a liquid-liquid centrifuge was determined to be particularly useful to process the aqueous suspension or emulsion into a “light phase” and a “heavy phase.” Such a liquid-liquid centrifuge is commercially available from Cinc Industries, Carson City, Nev.

According to the present invention the “light phase” includes from about 1 to about 15 percent by weight of paint overspray solids and from about 85 to about 98 percent by weight of water and (and less than about 1 wt. % dispersion chemistry). The “heavy phase” includes from about 40 to about 75 percent by weight of paint overspray solids and from about 24 to about 59 percent by weight water (and less than about 1 wt. % dispersion chemistry).

Since a large percentage of the water which contains the dispersion chemistry is recovered in the “light phase” and returned to the sludge pit or holding tank or to the water curtain and/or water stream provided beneath the floor grating of a paint booth, the process of the present invention reduces the amount of make-up water and dispersion chemistry that is needed to operate the overall system/process continuously.

The “heavy phase” (or “dirty phase”) that is collected can be as a fuel or fuel additive in combustion fuel energy facilities, by mixing the “heavy phase” with a carbonaceous material such as coal, coal fines, coke, coke breeze, coke fines, revert materials and mixtures thereof, using any suitable mixing apparatus, including grinders, and the resulting mixture is preheated prior to combustion. If desired, the treated or mixed carbonaceous materials can be in the form of individual particles, agglomerated particles, pelletized or briquetted materials, or any convenient form that can be fed into a combustion system such as a furnace, boiler, etc. The preheating prior to combustion allows for some evaporative losses and results in an increase in fuel value.

Alternatively the “heavy phase” (or “dirty phase”) can be processed and reused as a coating composition or the polymer from the paint formulations can be recovered and reused.

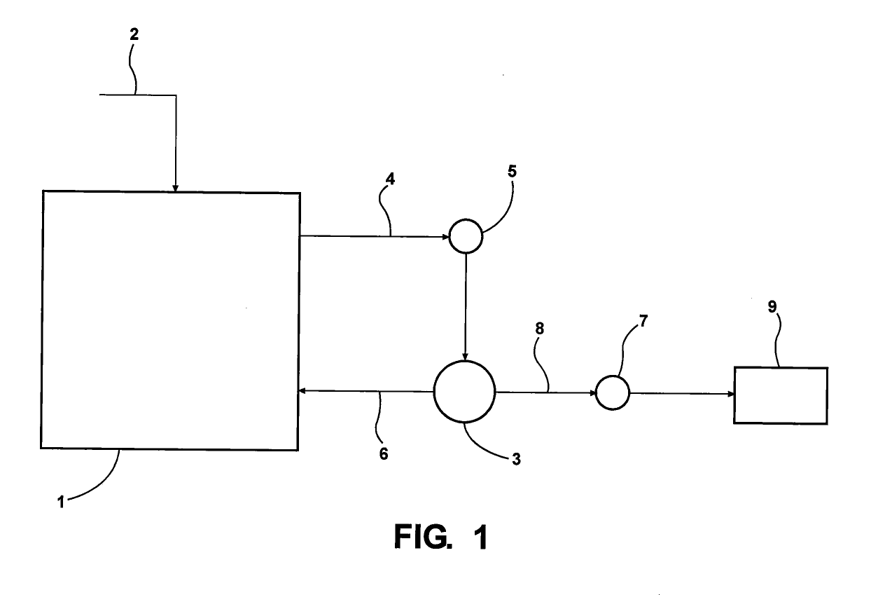

FIG. 1 is a diagram of a method for processing paint overspray according to one embodiment of the present invention. In FIG. 1 sludge pit or holding tank 1 receives the aqueous suspension or emulsion of paint overspray that is collected by water curtains and/or water streams that are provided beneath the floor grating of paint booths (not shown). As noted above, in a typical system that collects and recovers paint overspray the solids percent (by weight) in the aqueous suspension or emulsion generally ranges from about 1 to about 25% by weight and increases over this range as the painting process continues to operate.

As indicated in FIG. 1 various dispersion chemicals are added to the aqueous suspension or emulsion in the sludge pit or holding tank 1. Examples of typical dispersion chemicals include an emulsifying agent and a caustic agent (to control pH) which are depicted as being added to the sludge pit or holding tank 1 at 2. In addition, a biocide agent can be added to the aqueous suspension or emulsion to prevent bacterial growth. Further, a polymer agent can be added to the aqueous suspension or emulsion for separator enhancement. Examples of an emulsifying agent which was determined to be useful for purposes of the present invention was a combination of TXIB (trimethyl pentanyl diisobutyrate: Eastman) and oleic acid.

The sludge pit or holding tank 1 can be of conventional design and optionally equipped with means to agitate the aqueous suspension or emulsion. Such conventional agitation means include bubblers, mechanical agitators, pumps, etc.

In accordance with the present invention a portion of the aqueous suspension or emulsion is removed from the sludge pit or holding tank 1 and processed in a liquid-liquid centrifuge 3. For such processing, a portion of the aqueous suspension or emulsion is removed from the sludge pit or holding tank 1 at a convenient location as outlet 4 by pump 5 and fed into the inlet of the liquid-liquid centrifuge 2. The liquid-liquid centrifuge 2 separates the aqueous suspension or emulsion into a “light phase” that has a lower solids content than the bulk volume of the aqueous suspension or emulsion that is contained within the sludge pit or holding tank and a “heavy phase” that has a higher solids content than the bulk volume of the aqueous suspension or emulsion that is contained within the sludge pit or holding tank. The “light phase” is returned to the sludge pit or holding tank 1 at a convenient location 6 or recycled to the water curtain and/or the water stream that provided beneath the floor grating or a paint booth and the “heavy phase” (or “dirty phase”) is collected for disposal or further processing as discussed therein. As shown in FIG. 1 a paint solids waste pump 7 is connected to an outlet 8 of the liquid-liquid centrifuge 2 and used to transfer the “heavy phase” from the liquid-liquid centrifuge 2 to a collection receptacle.

During operation in conjunction with a sludge pit or holding tank that contained an aqueous suspension or emulsion having a solids content of greater than 12 wt. % a 4 GPM flow rate of aqueous suspension or emulsion was fed into the liquid-liquid centrifuge and separated into a “light phase” that had a solids content of about 6 wt. % and a “heavy phase” that had a solids content of about 55-58 wt. %.

During the course of the present invention it has been determined that the process of the present invention can be implemented with a liquid-liquid centrifuge that can receive an 8-10 GPM feed of an aqueous suspension or emulsion having a solids content of 10 wt. % or greater and produce a “light phase” having a solids content of less than 3 wt. % and a “heavy phase” having a solids content of 50 wt. % or greater.

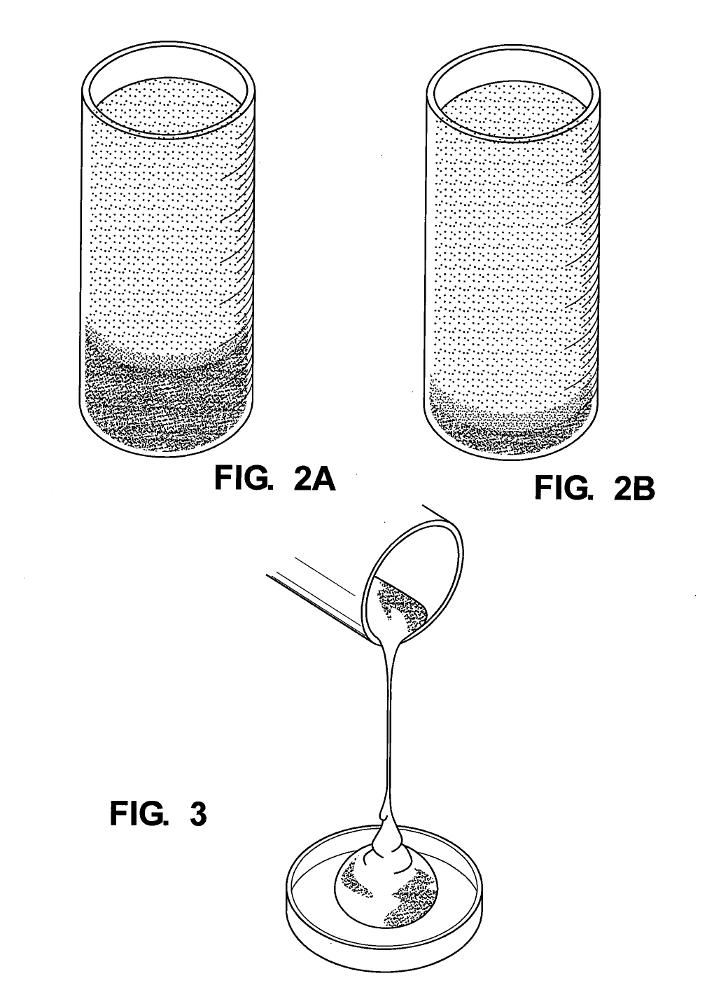

FIGS. 2a and 2b depict samples of aqueous suspensions or emulsions of paint overspray having different solids percentages that have settled. FIG. 2a depicts an aqueous suspension or emulsion of paint overspray that has a solids content of 12 wt. %. This corresponds to a solids content that is typically found in an aqueous suspension or emulsion a sludge pit or holding tank. FIG. 2b depicts an aqueous suspension or emulsion of paint overspray that has a solids content of 6 wt. %. This corresponds to a “light phase” solids content according to the present invention.

FIG. 3 depicts a sample of an aqueous suspension or emulsion of paint overspray that has a solids content of about 50 wt. %. This corresponds to a “heavy phase” solids content according to the present invention.

The differences between the solids content of aqueous suspension or emulsion a sludge pit or holding tank and a “light phase” and a “heavy phase” according to the present invention can be readily seen in FIGS. 2a-2b and FIG. 3.

As discussed above, the “heavy phase” (or “dirty phase”) obtained by the present invention is collected for disposal or further processing. When the “heavy phase” is collected and sent to a landfill it provides advantages over sending an aqueous suspension or emulsion typically found in a sludge pit or holding tank, i.e. one having a solids content of from about 1 to about 25 wt. % and often from about 10 to about 15 wt. % to a landfill. Rather a “heavy phase” according to the present invention having a solids content of from about 40 to about 75 wt. % would be more concentrated and have less volume per unit of paint overspray solids.

The present invention provides using the collected “heavy phase” as a combustible fuel product that provides significant fuel value for combustion processes such as fuels used in power and heat generating plants and facilities.

To use the “heavy phase” of the present invention as a fuel in combustion fuel energy facilities, the “heavy phase” can be mixed with a carbonaceous material such as coal, coal fines, coke, coke breeze, coke fines, revert materials and mixtures thereof, using any suitable mixing apparatus, and the resulting mixture is preheated prior to combustion. If desired, the treated or mixed carbonaceous materials can be in the form of individual particles, agglomerated particles, pelletized or briquetted materials, or any convenient form that can be fed into a combustion system such as a furnace, boiler, etc. The preheating prior to combustion allows for some evaporative losses and results in an increase in fuel value.

When completely dry, paint overspray solids will generate more than 10,000 Btu/lb of fuel value. A “heavy phase” having a solids content of 55-58 wt. % will have a Btu value (Btu/lb) of about 7,800 and a “heavy phase” having a solids content of 65 wt. % will have a Btu value of greater than 8,000.

It is also within the scope of the present invention use or process the “heavy phase” to be used as a coating composition. For example, the chemistry used to disperse the paint overspray solids can be reversed, neutralized, removed, etc. to produce or reformulate a coating composition.

It can be appreciated that by lowering the solids content from, for example, greater than 10 wt. % (of the aqueous suspension or emulsion in a sludge pit or holding tank) to less than 3 wt. % (of the “light phase”), the lower solids content portion which is returned to the sludge pit or holding tank or to the water curtain and/or water stream provided beneath the floor grating of a paint booth allows for more efficient and stable operation of a paint booth operation.

Moreover concentrating the paint solids overspray in the “heavy phase” (or “dirty phase”) allows for increasing the solids loading in collection, holding and transportation equipment.

By recycling an appreciable portion of the water (with the “light phase”), the dispersion chemistry is also recycled so that the amount of chemistry needed to replenish the system is lowered.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and set forth in the attached claims.

What is claimed is:

1. A method of processing paint overspray from an emulsion chemistry process which comprises the steps of:
a) obtaining paint overspray from a painting facility;
b) collecting the paint overspray in an aqueous medium;
c) subjecting the paint overspray to a chemical treatment to form an aqueous suspension or emulsion of paint overspray solids having a first solids content; and
d) processing the aqueous suspension or emulsion of paint overspray solids to form: i) a light phase that has a second solids content that is lower than the first solids content; and ii) a heavy phase that has a third solids content that is higher than the first solids content.

2. A method of processing paint overspray from an emulsion chemistry process according to claim 1, wherein steps b) and c) are performed substantially simultaneously.

3. A method of processing paint overspray from an emulsion chemistry process according to claim 1, wherein step d) comprises processing the aqueous suspension or emulsion of paint overspray solids in a liquid-liquid separator.

4. A method of processing paint overspray from an emulsion chemistry process according to claim 1, wherein step b) comprises collecting the paint overspray in a water curtain or a water stream.

5. A method of processing paint overspray from an emulsion chemistry process according to claim 1, wherein first solids content ranges from about 1 to about 25 wt. %, the second solids content ranges from about 1 to about 15 wt. % and the third solids content ranges from about 40 to about 75 wt. %.

6. A method of processing paint overspray from an emulsion chemistry process according to claim 5, wherein first solids content ranges from about 10 to about 25 wt. %, the second solids content ranges from about 1 to about 6 wt. % and the third solids content ranges from about 55 to about 75 wt. %.

7. A method of processing paint overspray from an emulsion chemistry process according to claim 1, wherein first solids content is greater than about 10 wt. %, the second solids content is less than about 3 wt. % and the third solids content is up to about 75 wt. %.

8. A method of processing paint overspray from an emulsion chemistry process according to claim 1, further comprising the step of storing the aqueous suspension or emulsion in a storage tank and removing a portion of the stored aqueous suspension or emulsion and processing that portion in step d).

9. A method of processing paint overspray from an emulsion chemistry process according to claim 1, wherein at least a portion of the aqueous medium in step b) comprises the light phase.

10. A method of processing paint overspray from an emulsion chemistry process according to claim 1, wherein the heavy phase is disposed in a landfill.

11. A method of processing paint overspray from an emulsion chemistry process according to claim 1, wherein the heavy phase is processed into a combustible fuel.

12. A method of processing paint overspray from an emulsion chemistry process according to claim 1, wherein the heavy phase is used to produce a coating composition.

13. A system for processing paint overspray from an emulsion chemistry process which comprises:
at least one spray paint application station;
an aqueous medium for collecting paint overspray from the at least one spray paint application station;
means for adding chemical agents to the collected paint overspray to form an aqueous suspension or emulsion of paint overspray solids having a first solids content; and
a liquid-liquid separator for processing the aqueous suspension or emulsion of paint overspray solids to form: i) a light phase that has a second solids content that is lower than the first solids content; and ii) a heavy phase that has a third solids content that is higher than the first solids content.

14. A system for processing paint overspray from an emulsion chemistry process according to claim 13, wherein the liquid-liquid separator comprises a centrifuge.

15. A system for processing paint overspray from an emulsion chemistry process according to claim 13, wherein the aqueous medium comprises a water curtain or a water stream.

16. A system for processing paint overspray from an emulsion chemistry process according to claim 13, further comprising a holding tank for receiving and containing the aqueous suspension or emulsion and a pump connected between the holding tank and the liquid-liquid separator.

17. A system for processing paint overspray from an emulsion chemistry process according to claim 15, wherein the liquid-liquid separator comprises an inlet for receiving the aqueous suspension or emulsion and one outlet for directing the light phase to at least one of the water curtain or water stream and a holding tank and a second outlet for directing the heavy phase to at least one of a collection container, a holding tank and transportation container.
